(19) United States
(12) Patent Application Publication
(10) Pub. No.: US 2025/0242808 A1
(43) Pub. Date: Jul. 31, 2025

(54) METHOD OF GENERATING SPEED PROFILE FOR SPEED CONTROL OF AUTONOMOUS VEHICLE, COMPUTING DEVICE, AND RECORDING MEDIUM

(71) Applicant: RideFlux Inc., Jeju-si (KR)

(72) Inventors: Sungpil YANG, Jeju-si (KR); Jiwoong KIM, Seoul (KR); Ho YUN, Jeju-si (KR)

(73) Assignee: RideFlux Inc., Jeju-si (KR)

(21) Appl. No.: 19/006,578

(22) Filed: Dec. 31, 2024

(30) Foreign Application Priority Data
Jan. 26, 2024 (KR) 10-2024-0012567

(51) Int. Cl. B60W 30/14; B60W 50/00; B60W 60/00

(52) U.S. Cl. CPC B60W 30/143; B60W 50/00; B60W 60/001; B60W 2050/0083; B60W 2520/105

(57) ABSTRACT

There are provided a method of generating a speed profile for speed control of an autonomous vehicle, a device, and a recording medium. According to one embodiment of the present invention, a method of generating a speed profile for speed control of an autonomous vehicle, which is performed by a computing device, includes setting a plurality of zones by dividing a two-dimensional domain zone defined by a speed and an acceleration, selecting a zone corresponding to a current speed and acceleration of an autonomous vehicle among the plurality of zones, and generating a speed profile for controlling a speed such that a speed of the autonomous vehicle reaches a target speed based on the selected zone.

### CROSS-REFERENCE TO RELATED APPLICATION

This application claims priority to and the benefit of Korean Patent Application No. 10-2024-0012567, filed on Jan. 26, 2024, the disclosure of which is incorporated herein by reference in its entirety.

### BACKGROUND

### 1. Field of the Invention

Various embodiments of the present invention relate to a method of generating a speed profile for speed control of an autonomous vehicle, a device, and a recording medium.

### 2. Discussion of Related Art

For the convenience of users who drive vehicles, various sensors and electronic devices (for example, advanced driver assistance systems (ADASs)) are being provided, and in particular, technologies for autonomous driving systems for vehicles that recognize the surrounding environment without driver intervention and automatically travel to a given destination based on the recognized surrounding environment are being actively developed.

Autonomous vehicles are vehicles equipped with an autonomous driving system function of recognizing the surrounding environment without driver intervention and automatically traveling to a given destination based on the recognized surrounding environment. An autonomous driving system function is a function of performing positioning, recognition, prediction, planning, and control for autonomous driving.

Autonomous driving systems detect objects positioned around autonomous vehicles by processing point cloud data acquired through a recognition process by sensors (for example, LiDAR sensors) and receive recognition results (for example, information such as a position, a posture, and a speed of an object) derived by performing the recognition process, thereby establishing a driving plan for a route, a speed, and the like of an autonomous vehicle through a planning process.

### SUMMARY OF THE INVENTION

A planning process performed by an autonomous driving system generates trajectory information about a trajectory along which an autonomous vehicle will travel for a certain time (for example, 5 seconds) in the future and generates trajectory information at sufficiently short intervals (for example, 0.1 seconds) to respond to a driving environment that changes in real time, thereby enabling the operation of the autonomous vehicle to be controlled through a control process based on the trajectory information generated at short intervals.

The control process in the autonomous driving system controls the autonomous vehicle to move longitudinally and/or laterally to follow a trajectory with reference to the trajectory information.

Typically, when the surrounding conditions do not change significantly between a plan established at a specific time point and a plan established at a next time point, a trajectory according to the plan established at the specific time point and a trajectory according to the plan established at the next time point should be constant. However, when these trajectories are not constant, there may be problems in that ride comfort and driving stability are lowered.

In addition, a control process controls the movement of an autonomous vehicle with reference to trajectory information derived through a planning process, and control performance is improved only when a trajectory is generated in a form that may follow the trajectory well.

Accordingly, the present invention is directed to providing a method of generating a speed profile for speed control of an autonomous vehicle, a device, and a recording medium in which a plurality of zones are set by dividing a two-dimensional domain zone defined by a speed and acceleration according to a predefined speed-acceleration relation, and a speed profile for an autonomous vehicle is generated based on a zone corresponding to a current speed and acceleration of the autonomous vehicle, thereby generating a speed profile that allows excellent ride comfort to be maintained even in a wide speed range when a current speed is increased or decreased to reach a target speed.

The technical problems to be solved by the present invention are not limited to the above-described problems, and any other technical problems that are not described herein will be clearly understood from the following description by those skilled in the art to which the present invention pertains.

According to an aspect of the present invention, there is provided a method of generating a speed profile for speed control of an autonomous vehicle, which is performed by a computing device, the method including setting a plurality of zones by dividing a two-dimensional domain zone defined by a speed and an acceleration, selecting a zone corresponding to a current speed and acceleration of an autonomous vehicle among the plurality of zones, and generating a speed profile for controlling a speed such that a speed of the autonomous vehicle reaches a target speed based on the selected zone.

The setting of the plurality of zones may include setting a plurality of parameters related to a speed, an acceleration, and a jerk, setting a plurality of boundary lines in the domain zone using the plurality of set parameters, and setting the plurality of zones by dividing the domain zone using the plurality of set boundary lines.

The setting of the plurality of boundary lines may include setting a first boundary line in a form of an acceleration parabola in the domain zone, setting a second boundary line in a form of a deceleration parabola in the domain zone, and setting a third boundary line in a form of a straight line combination including a plurality of different straight lines in the domain zone.

The setting of the first boundary line may include setting a plurality of parabolas, which have a first jerk value and individually pass a zero point in the domain zone, points corresponding to boundaries of sections of the plurality of straight line, and a point corresponding to the target speed, based on a predefined speed-acceleration relation.

The setting of the second boundary line may include setting a plurality of parabolas, which have a second jerk value and individually pass points corresponding to boundaries of sections of the plurality of straight line in the domain zone and a point corresponding to the target speed, based on a predefined speed-acceleration relation.

The setting of the third boundary line may include setting a first unit boundary line in a form of a constant function which has a jerk value of 0 and in which an acceleration value according to a speed change is a preset positive minimum acceleration value or a preset negative maximum acceleration value, setting a second unit boundary line in a form of a constant function which has a jerk value of 0 and in which an acceleration value according to a speed change is a preset positive maximum acceleration value or a preset negative minimum acceleration value, and setting a third unit boundary line in a form of a first-order function which connects the set first unit boundary line and the set second unit boundary line and has a jerk value proportional to an acceleration value according to a speed change.

The setting of the plurality of parameters may include setting the plurality of parameters such that preset constraints are satisfied, wherein the preset constraints are set such that each of a plurality of parabolas included in a first boundary line generated using the plurality of set parameters and a third boundary line generated using the plurality of set parameters have one intersection point, and each of a plurality of parabolas included in a second boundary line generated using the plurality of set parameters and the third boundary line have one intersection point.

The plurality of set parameters may include at least one of a positive maximum acceleration value, a positive minimum acceleration value, a negative maximum acceleration value, a negative minimum acceleration value, a jerk value, a difference value between the target speed and a speed corresponding to the positive maximum acceleration value based on a predefined speed-acceleration relation, a difference value between the target speed and a speed corresponding to the positive minimum acceleration value based on the predefined speed-acceleration relation, a difference value between the target speed and a speed corresponding to the negative maximum acceleration value based on the predefined speed-acceleration relation, and a difference value between the target speed and a speed corresponding to the negative minimum acceleration value based on the predefined speed-acceleration relation.

The selecting of the zone may include selecting a zone, in which a point corresponding to the current speed and acceleration of the autonomous vehicle is positioned, among the plurality of zones set in the domain zone.

The generating of the speed profile may include generating a speed profile for controlling the speed and acceleration of the autonomous vehicle such that a point corresponding to the speed and acceleration of the autonomous vehicle follows a parabola parallel to a speed-acceleration relation corresponding to the selected zone and, the point corresponding to the speed and acceleration of the autonomous vehicle follows a specific boundary line when the point corresponding to the speed and acceleration of the autonomous vehicle is positioned on the specific boundary line in the domain zone.

The method may further include, when a difference between the current speed and the target speed is less than a threshold value, generating a speed profile for controlling the autonomous vehicle to maintain the current speed.

The method may further include, when there is no zone corresponding to the current speed and acceleration of the autonomous vehicle among the plurality of set zones, generating a first speed profile for performing control such that a speed and acceleration of the autonomous vehicle are 0, and when the current speed and acceleration of the autonomous vehicle becomes 0 according to the generated first speed profile, generating a second speed profile using a zone corresponding to the current speed and acceleration of the autonomous vehicle being 0 among the plurality of set zones.

The method may further include, when it is determined that the current speed is less than the target speed in a state in which the acceleration is a negative value, or the current speed is greater than the target speed in a state in which the acceleration is a positive value, generating a speed profile for reversing an acceleration direction of the autonomous vehicle based on a preset jerk value.

The generating of the speed profile for reversing the acceleration direction of the autonomous vehicle may include generating the speed profile for reversing the acceleration direction of the autonomous vehicle only when a difference between the current speed and the target speed is greater than or equal to a threshold value.

The setting of the plurality of zones may include dividing the two-dimensional domain zone to include a section using an acceleration having a magnitude proportional to a difference between the speed of the autonomous vehicle and the target speed.

According to another aspect of the present invention, there is provided a computing device for performing a method of generating a speed profile for speed control of an autonomous vehicle, the computing device including a processor, a network interface, a memory, and a computer program loaded to the memory and executed by the processor, wherein the computer program includes an instruction for setting a plurality of zones by dividing a two-dimensional domain zone defined by a speed and an acceleration, an instruction for selecting a zone corresponding to a current speed and an acceleration of an autonomous vehicle among the plurality of zones, and an instruction for generating a speed profile for controlling a speed such that a speed of the autonomous vehicle reaches a target speed based on the selected zone.

According to still another aspect of the present invention, there is a computing device-readable recording medium, on which a computer program coupled to a computing device to execute a method of generating a speed profile for speed control of an autonomous vehicle is recorded, wherein the method includes setting a plurality of zones by dividing a two-dimensional domain zone defined by a speed and an acceleration, selecting a zone corresponding to a current speed and an acceleration of an autonomous vehicle among the plurality of zones, and generating a speed profile for controlling a speed such that a speed of the autonomous vehicle reaches a target speed based on the selected zone.

Other specific details of the present invention are included in the detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an autonomous driving system according to one embodiment of the present invention;

FIG. 2 is a hardware block diagram of a computing device according to another embodiment of the present invention;

FIG. 3 is a flowchart illustrating a method of generating a speed profile for speed control of an autonomous vehicle according to still another embodiment of the present invention;

FIG. 4 is an exemplary diagram illustrating a software framework for a method of generating a speed profile for speed control of an autonomous vehicle in various embodiments;

FIG. 5 is a flowchart for describing a method of setting a plurality of zones in various embodiments;

FIG. 6 is a diagram exemplarily illustrating a plurality of zones set in a speed-acceleration domain zone;

FIG. 7 shows diagrams for describing a process of determining a gradient of a second unit boundary line included in a third boundary line in various embodiments;

FIG. 8 is a diagram for describing a process of generating a speed profile by a computing device in various embodiments;

FIGS. 9 to 15 are diagrams exemplarily illustrating a speed profile generated for each zone corresponding to a current speed and acceleration of an autonomous vehicle in various embodiments;

FIG. 16 is a diagram exemplarily illustrating a form in which a target zone having a margin with a predetermined size is set centered on a position corresponding to a target speed in a domain zone in various embodiments;

FIG. 17A and FIG. 17B shows diagrams for describing a process of generating a speed profile when there is no zone corresponding to a current speed and acceleration of an autonomous vehicle in various embodiments; and

FIG. 18A and FIG. 18B shows diagrams for describing a process of reversing an acceleration direction of an autonomous vehicle through a jerk jump in various embodiments.

### DETAILED DESCRIPTION OF EXEMPLARY EMBODIMENTS

The advantages and features of the present invention and methods of accomplishing the same will become apparent from the following description of the embodiments in detail, taken in conjunction with the accompanying drawings. However, the present invention is not limited to the embodiments disclosed herein but can be implemented in various forms. The embodiments are provided so that the present invention is completely disclosed, and a person of ordinary skilled in the art can fully understand the scope of the present invention. Therefore, the present invention will be defined only by the scope of the appended claims.

Terms used herein are for the purpose of describing embodiments only and are not intended to limit the present invention. As used herein, the singular forms are intended to include the plural forms as well, unless the context clearly indicates otherwise. It will be further understood that the terms “comprises” and/or “comprising,” used in this specification do not preclude the presence or addition of one or more other components in addition to the described components.

Throughout the present specification, the same reference numerals are used to indicate the same components, and the term “and/or” includes each of the described components and all combinations of one or more thereof. It will be understood that, although the terms “first,” “second,” and the like are used herein to describe various components, these components should not be limited by these terms. These terms are merely used to distinguish one component from another. Therefore, of course, a first component to be described below may be a second component in a technical concept of the present invention.

As used herein, the term “unit” or “module” refers to a software element or a hardware element such as a field-programmable gate array (FPGA) or an application-specific integrated circuit (ASIC) and performs certain functions. However, the term “module” or “unit” is not limited to software or hardware. The “unit” or “module” may be formed to be in an addressable storage medium or may be formed to operate one or more processors. Thus, as example, the term “unit” or “module” includes components such as software components, object-oriented software components, class components, and task components, processes, functions, attributes, procedures, subroutines, segments of program code, drivers, firmware, micro-codes, circuits, data, a database, data structures, tables, arrays, and variables. Functions provided by the components and “units” or “modules” may be combined into the smaller number of components and “units” or “modules” or may be further divided into additional components and “units” or “modules.”

Spatially relative terms “below,” “beneath,” “lower,” “above,” “upper,” and the like may be used to easily describe a correlation between a component and other components as shown in the drawings. Spatially relative terms should be understood as terms including different directions of components during use or operation in addition to a direction shown in the drawings. For example, when components shown in the drawing are reversed, a component described as “below” or “beneath” another component may be placed “above” the other component. Thus, the example term “below” may include both orientations of below and above. Components may also be oriented in other directions, and accordingly, spatially relative terms may be interpreted according to orientation.

As used herein, expressions such as “first” and “second” are used to distinguish one object from another when referring to a plurality of objects of the same kind unless the context indicates otherwise, and do not limit the order or importance among the relevant objects.

As used herein, expressions such as “A, B, and C,” “A, B, or C,” “A, B, and/or C,” “at least one of A, B, and C,” “at least one of A, B, or C,” “at least one of A, B, and/or C,” “at least one selected from A, B, and C,” “at least one selected from A, B, or C,” and “at least one selected from A, B, and/or C” may mean each listed item or all possible combinations of the listed items. For example, “at least one selected from A and B” may refer to all of (1) A, (2) at least one A, (3) B, (4) at least one B, (5) at least one A and at least one B, (6) B and at least one A, (7) A and at least one of B, and (8) A and B.

As used herein, the expression “based on” is used to describe one or more factors that affect the action or operation of a decision or determination described in the phrase or sentence including the expression, and this expression does not preclude additional factors that affect the action or operation of that decision or determination.

As used herein, the expression that a component (e.g., a first component) is “connected” or “coupled” to another component (e.g., a second component) may mean that any component is connected or coupled to another component directly, as well as connected or coupled via yet another component (e.g., a third component).

As used herein, the expression “configured to” may have the meaning of “set to,” “having the ability to,” “modified to,” “made to,” “capable of,” etc., depending on the context. The expression is not limited to the meaning of “designed specifically in hardware,” and for example, a processor configured to perform a particular operation may refer to a generic-purpose processor capable of performing that particular operation by executing software.

Unless otherwise defined, all terms (including technical and scientific terms) used herein have the same meaning as commonly understood by one having ordinary knowledge in the art to which the present invention belongs. Further, terms defined in a commonly used dictionary are not to be interpreted ideally or excessively unless otherwise defined.

In this specification, a computer can be any type of hardware device including at least one processor and may be understood to encompass software configurations operating in the corresponding hardware device according to embodiments. For example, a computer may be understood to be a smart phone, a tablet personal computer (PC), a desktop computer, a notebook computer, a user client, or an application running on any of these devices, but the present invention is not limited thereto.

Hereinafter, embodiments of the present invention will be described in detail with reference to the accompanying drawings.

Each of operations described in the specification is described as being performed by a computer, but the agent of each operation is not limited thereto, and at least some of the operations may be performed in different devices according to embodiments.

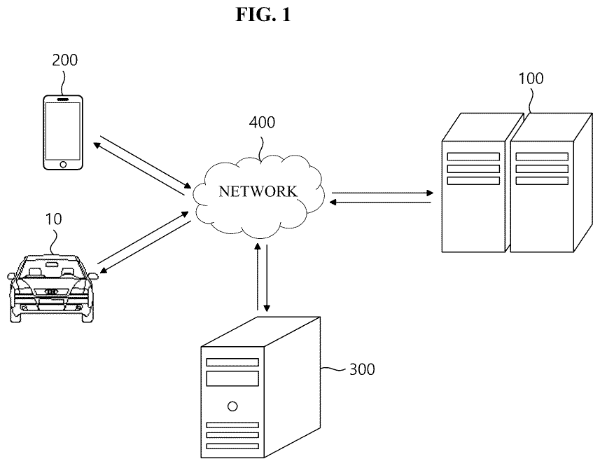

FIG. 1 is a diagram illustrating an autonomous driving system according to one embodiment of the present invention.

Referring to FIG. 1, the autonomous driving system according to one embodiment of the present invention may include a computing device 100, a user terminal 200, an external server 300, and a network 400.

Here, the autonomous driving system shown in FIG. 1 is according to one embodiment, and components thereof are not limited to the embodiment shown in FIG. 1, and some components may be added, changed, or omitted as needed.

In one embodiment, the computing device 100 may perform autonomous driving control on an autonomous vehicle 10. To this end, the computing device 100 may perform a positioning operation, a recognition operation, a determination operation, and a control operation.

Here, according to the autonomous driving system shown in FIG. 1, the computing device 100 may be separately provided outside the autonomous vehicle 10, may determine a control instruction related to autonomous driving outside the autonomous vehicle 10, and may transmit the control instruction related to autonomous driving to the autonomous vehicle 10, thereby allowing the autonomous vehicle 10 to perform an autonomous driving operation. However, the present invention is not limited thereto, and the computing device 100 may correspond to one of the components provided inside the autonomous vehicle 10 and may perform autonomous driving control on the autonomous vehicle 10 by determining a control instruction related to autonomous driving inside the autonomous vehicle 10 and directly controlling the components of the autonomous vehicle 10 according to the control instruction related to autonomous driving. For example, the computing device 100 may be a control module that controls the operations of the components included in the autonomous vehicle 10 inside the autonomous vehicle 10.

More specifically, the positioning operation performed by the computing device 100 may be an operation of measuring a position and posture of the autonomous vehicle 10. For example, the computing device 100 may collect sensor data (for example, point cloud data, image data, or the like) by scanning the surrounding environment of the autonomous vehicle 10 using sensors (for example, a LiDAR, a radar, a camera, a Global Navigation Satellite System/Inertial Navigation System (GNSS/INS), and an inertial measurement unit (IMU)) installed in the autonomous vehicle 10, and may derive positioning information including positioning values corresponding to the position and posture of the autonomous vehicle 10 using the collected sensor data.

Next, the recognition operation performed by the computing device 100 may be an operation of detecting and tracking objects positioned around the autonomous vehicle 10. For example, the computing device 100 may recognize objects present around the autonomous vehicle 10 by analyzing sensor data (for example, point cloud data) collected by scanning the surroundings of the autonomous vehicle 10 and may derive recognition information including information about the recognized objects.

Next, a planning operation performed by the computing device 100 may be an operation of generating a driving trajectory including a path and a speed profile for controlling the autonomous vehicle 10 based on positioning information derived through a positioning module and recognition information derived through a recognition module.

Finally, the control operation performed by the computing device 100 may be an operation of determining and generating a control instruction for lateral control (direction control) and longitudinal control (speed control) of the autonomous vehicle 10 based on information about the driving trajectory derived through the planning operation and controlling the operation of the autonomous vehicle 10 according to the determined and generated control instruction.

In various embodiments, the computing device 100 may be connected to the user terminal 200 through the network 400 and may provide various types of information related to autonomous driving to the user terminal 200 (for example, a high-precision map of a predetermined zone, recognition results of objects around the autonomous vehicle 10, control instructions for autonomous driving control, and operation information of the autonomous vehicle 10 according to the control instructions).

Here, the user terminal 200 may be any type of entity (or entities) in a system having a mechanism for communicating with the computing device 100. For example, the user terminal 200 may include a PC, a notebook computer, a mobile terminal, a smartphone, a tablet PC, a wearable device, or the like and may include any type of terminal that can be connected to wired/wireless networks. In addition, the user terminal 200 may include any computing device implemented by at least one of an agent, an application programming interface (API), and a plug-in. In addition, the user terminal 200 may include an application source and/or a client application.

In addition, here, the network 400 may be a connection structure that enables information exchange between nodes such as a plurality of terminals and servers. For example, the network 400 may include a local area network (LAN), a wide area network (WAN), the Internet (WWW: World Wide Web), wired and wireless data communication networks, a telephone network, wired and wireless television communication networks, a controller area network (CAN), Ethernet, and the like.

The wireless data communication network may include, 3G, 4G, 5G, 3^{rd} Generation Partnership Project (3GPP), 5th Generation Partnership Project (5GPP), Long Term Evolution (LTE), World Interoperability for Microwave Access (WIMAX), Wi-Fi, the Internet, a LAN, a wireless LAN, a WAN, a personal area network (PAN), a radio frequency (RF) network, a Bluetooth network, a near-field communication (NFC) network, a satellite broadcasting network, an analog broadcasting network, a digital multimedia broadcasting (DMB) network, and the like, but the present invention is not limited thereto.

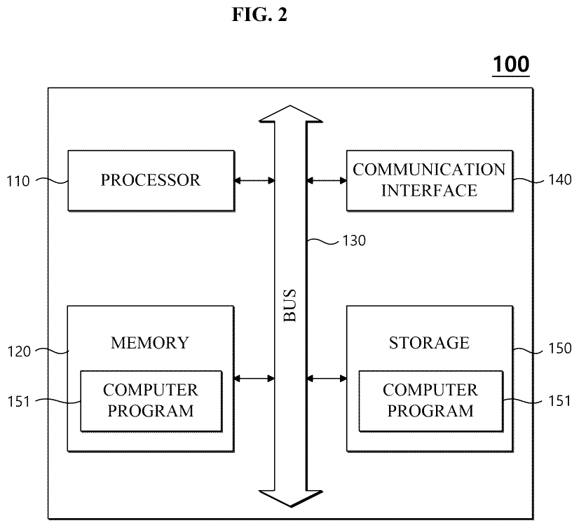

In one embodiment, the external server 300 may be connected to the computing device 100 through the network 400 and may store and manage various types of information and data required for the computing device 100 to perform a method of generating a speed profile for speed control of an autonomous vehicle or may collect, store, and manage various types of information and data derived when the computing device 100 performs the method of generating a speed profile for speed control of an autonomous vehicle. For example, the external server 300 may be a storage server separately provided outside the computing device 100 but is not limited thereto. Hereinafter, a hardware configuration of the computing device 100 that performs a method of generating a speed profile for speed control of an autonomous vehicle will be described with reference to FIG. 2.

FIG. 2 is a hardware block diagram of a computing device according to another embodiment of the present invention.

Referring to FIG. 2, in various embodiments, a computing device 100 may include one or more processors 110, a memory 120 for loading a computer program 151 executed by the processor 110, a bus 130, a communication interface 140, and a storage 150 for storing the computer program 151. Here, only components related to an embodiment of the present invention are shown in FIG. 2. Accordingly, a person skilled in the art to which the present invention belongs will appreciate that general components may be further included in addition to the components shown in FIG. 2.

The processor 110 controls the overall operation of each component of the computing device 100. The processor 110 may include a central processing unit (CPU), a microprocessor unit (MPU), a microcontroller unit (MCU), a graphics processing unit (GPU), or any type of processor well known in the art of the present invention.

In addition, the processor 110 may perform calculations on at least one application or program for executing methods according to embodiments of the present invention, and the computing device 100 may include or more processors.

In various embodiments, the processor 110 may further include a random access memory (RAM) (not shown) and a read-only memory (ROM) (not shown) which temporarily and/or permanently store signals (or data) processed inside the processor 110. In addition, the processor 110 may be implemented in the form of a system-on chip (SoC) including at least one of a GPU, a RAM, and a ROM.

The memory 120 stores various types of data, instructions, and/or information. The memory 120 may load the computer program 151 from the storage 150 to execute methods/operations according to various embodiments of the present invention. When the computer program 151 is loaded to the memory 120, the processor 110 may perform the methods/operations by executing one or more instructions constituting the computer program 151. The memory 120 may be implemented as a volatile memory such as a RAM, but the technical scope of the present invention is not limited thereto.

The bus 130 provides communication functions between the components of the computing device 100. The bus 130 may be implemented as various types of buses such as an address bus, a data bus, and a control bus.

The communication interface 140 supports wired and wireless Internet communication of the computing device 100. In addition, the communication interface 140 may support various communication methods other than Internet communication. For this purpose, the communication interface 140 may include a communication module well known in the art of the present invention. In some embodiments, the communication interface 140 may be omitted.

The storage 150 may non-temporarily store the computer program 151. When a process of generating a speed profile for speed control of an autonomous vehicle is performed through the computing device 100, the storage 150 may store various types of information necessary to provide the process of generating a speed profile for speed control of an autonomous vehicle.

The storage 150 may include a nonvolatile memory such as a ROM, an erasable programmable ROM (EPROM), an electrically erasable programmable ROM (EEPROM), a flash memory, a hard disk, a removable disk, or any form of computer-readable recording medium well known in the art to which the present invention belongs.

The computer program 151 may include one or more instructions that, when the computer program 151 is loaded to the memory 120, cause the processor 110 to perform methods/operations according to various embodiments of the present invention. That is, the processor 110 may perform the methods/operations according to various embodiments of the present invention by executing the one or more instructions.

In one embodiment, the computer program 151 may include one or more instructions that cause performing of a method of generating a speed profile for speed control of an autonomous vehicle, the method including setting a plurality of zones by dividing a two-dimensional domain zone defined by a speed and an acceleration, selecting a zone corresponding to a current speed and acceleration of an autonomous vehicle among the set plurality of zones, and generating a speed profile for speed control based on the selected zone such that a speed of the autonomous vehicle reaches a target speed.

Operations of a method or algorithm described in relation to an embodiment of the present invention may be implemented directly in hardware, implemented in a software module executed by hardware, or implemented in a combination thereof. The software module may reside on a RAM, a ROM, an EPROM, an EEPROM, a flash memory, a hard disk, a removable disk, a CD-ROM, or a computer readable recording medium in any form well known in the art to which the present invention belongs.

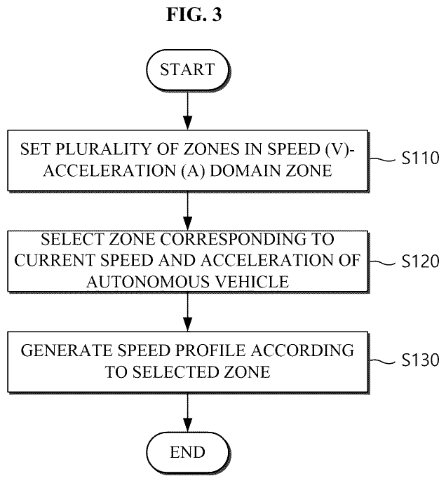

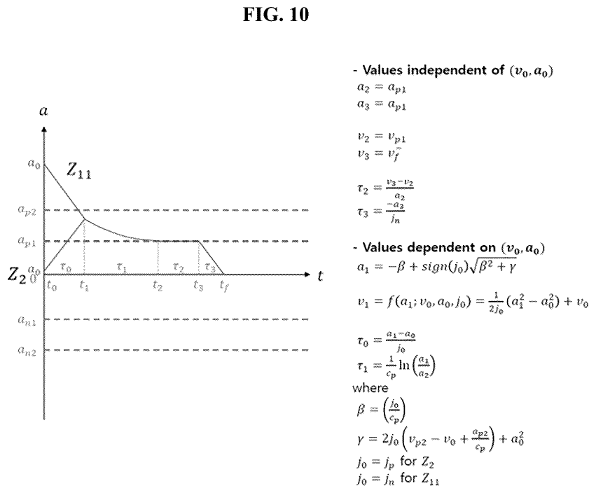

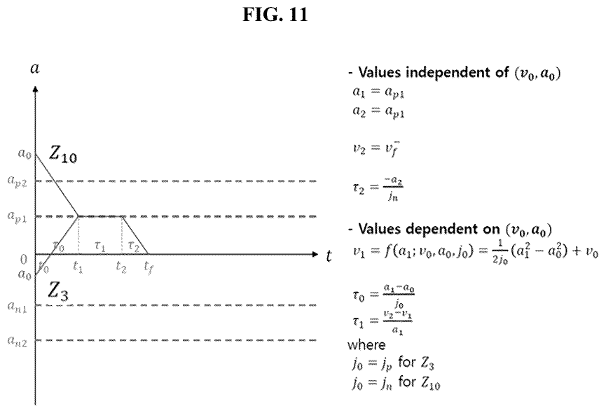

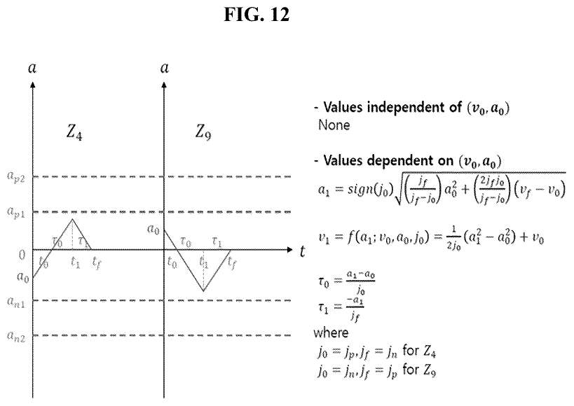

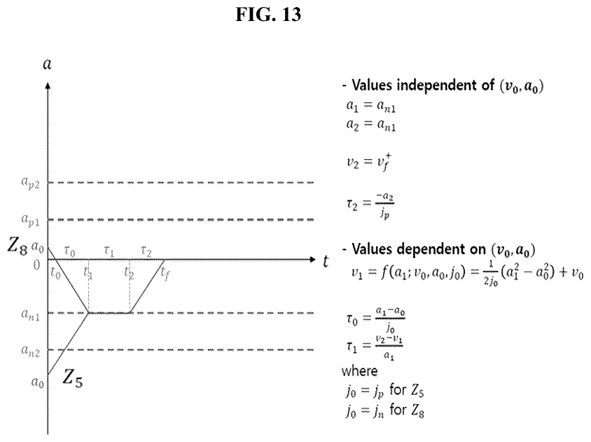

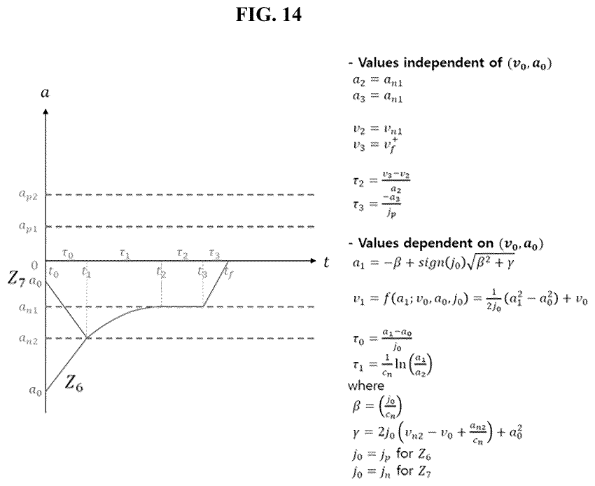

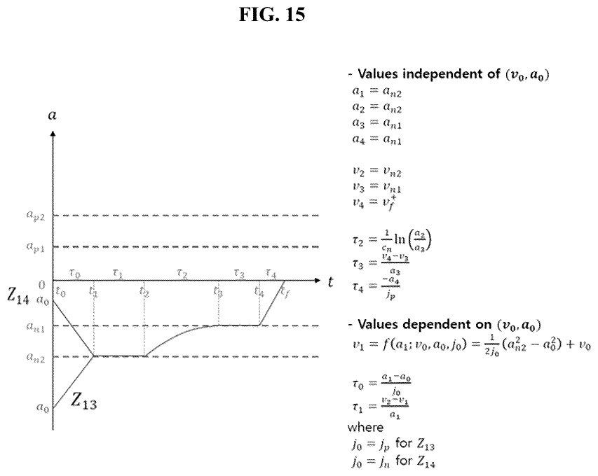

The components of the present invention may be implemented using a program (or application) to be executed in combination with a computer, which is hardware, and may be stored in a medium. The components of the present invention may be implemented through software programming or software elements, and similarly, the embodiments may be implemented with any programming or scripting language such as C, C++, Java, assembler language, or the like, with the various algorithms being implemented with any combination of data structures, objects, processes, routines, or other programming elements. Functional aspects may be implemented in algorithms that are executed on one or more processors. A method of generating a speed profile for speed control of an autonomous vehicle performed by the computing device 100 will be described in more detail with reference to FIGS. 3 to 18.

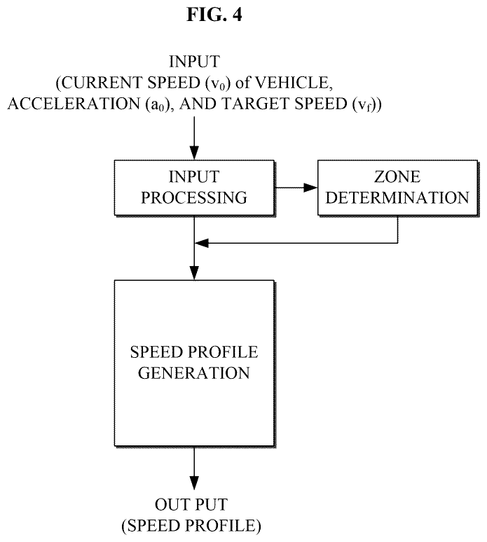

FIG. 3 is a flowchart illustrating a method of generating a speed profile for speed control of an autonomous vehicle according to still another embodiment of the present invention. FIG. 4 is an exemplary diagram illustrating a software framework for the method of generating a speed profile for speed control of an autonomous vehicle in various embodiments.

Referring to FIGS. 3 and 4, in operation S110, the computing device 100 may set a plurality of zones by dividing a two-dimensional domain zone defined by a speed and acceleration.

In various embodiments, the computing device 100 may set a plurality of parameters related to a speed, an acceleration, and a jerk, may set a plurality of boundary lines in a domain zone using a predefined speed-acceleration relation and the plurality of parameters, and may set a plurality of zones by dividing the domain zone using the plurality of boundary lines.

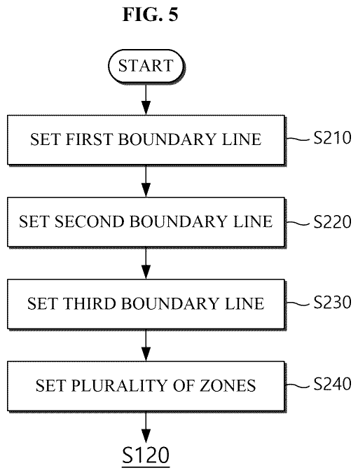

Here, the plurality of parameters may be parameters for setting a boundary line in the domain zone, and for example, the plurality of parameters may include the maximum acceleration/deceleration value a_{M}, the minimum acceleration/deceleration value a_{M}, a jerk value j, the maximum jerk value jₘₐₓ, a difference value Δv₁ between a target speed v_{f} and a speed corresponding to the minimum acceleration/deceleration value based on a predefined speed-acceleration relation, and a difference value Δv₂ between the target speed v_{f} and a speed corresponding to the maximum acceleration/deceleration value a_{M} based on the predefined speed-acceleration relation, but the present invention is not limited thereto. Hereinafter, a method of setting a plurality of zones performed by the computing device 100 will be described with reference to FIGS. 5 to 7.

FIG. 5 is a flowchart illustrating a method of setting a plurality of zones in various embodiments.

Referring to FIG. 5, in operation S210, the computing device 100 may set a first boundary line. Here, the first boundary line may be a boundary line in the form of an acceleration parabola set in a domain zone.

In various embodiments, the computing device 100 may set a parabola having a first jerk value as the first boundary line based on a predefined speed-acceleration relation.

Here, the predefined speed-acceleration relation may be an expression calculated using the fact that a jerk value is a rate of change of acceleration and an acceleration value is a rate of change of speed and may be expressed as in Expressions 1 and 2 below.

$${a}^{2} = {a}_{0}^{2} + 2 j ( v - {v}_{0} ) \qquad Expression 1$$

$$\frac{{a}^{2} - {a}_{0}^{2}}{2 j} + {v}_{0} = v \qquad Expression 2$$

Here, a may be an acceleration, a₀ may be a current acceleration of the autonomous vehicle 10, j may be a jerk value, v may be a speed, and v₀ may be a current speed of the autonomous vehicle 10.

In this case, when the computing device 100 sets a third boundary line in the form of a straight line combination including a plurality of different straight lines through operation S230 to be described below, the computing device 100 may generate a plurality of parabolas that individually pass a zero point (0, 0) in the domain zone, points corresponding to boundaries of sections of the plurality of straight lines included in the third boundary line, and a point (v_{f}, 0) corresponding to a target speed.

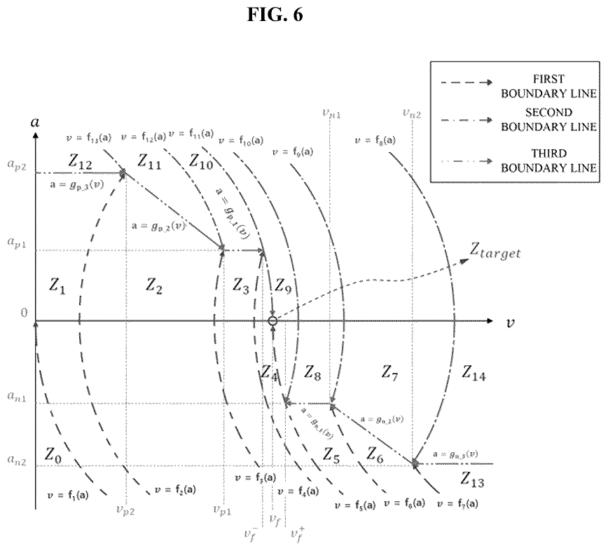

As an example, as shown in FIG. 6, when the points corresponding to the boundaries of the sections of the plurality of straight lines included in the third boundary line include three points positioned in an acceleration section and three points positioned in a deceleration section, the computing device 100 may generate, as the first boundary line, a first parabola f₁(a) passing through the zero point, a second parabola f₂(a), a third parabola f₃(a), and a fourth parabola f₄(a) which passe through three points positioned in the acceleration section, a fifth parabola f₅(a) passing through a point corresponding to a target speed and one point positioned in the deceleration section, and a sixth parabola f₆(a) and a seventh parabola f₇(a) which pass the remaining two points positioned in the deceleration section. Here, the first to seventh parabolas f₁(a) to f₇(a) may be acceleration parabolas. However, one or more embodiments are not limited thereto.

In operation S220, the computing device 100 may set a second boundary line. Here, the second boundary line may be a boundary line in the form of a deceleration parabola set in the domain zone.

In various embodiments, the computing device 100 may set a parabola having a second jerk value as the second boundary line based on a predefined speed-acceleration relation.

In this case, when the computing device 100 sets the third boundary line in the form of a straight line combination including a plurality of different straight lines through operation S230 to be described below, the computing device 100 may generate a plurality of parabolas that individually pass points corresponding to boundaries of sections of the plurality of straight lines included in the third boundary line, and a point (v_{f},0) corresponding to the target speed.

For example, as shown in FIG. 6, when the points corresponding to the boundaries of the sections of the plurality of straight lines included in the third boundary line include three points positioned in the acceleration section and three points positioned in the deceleration section, the computing device 100 may generate, as the second boundary line, an eighth parabola f₈(a), a ninth parabola f₉(a), and a tenth parabola f₁₀(a) which pass three points positioned in the deceleration section, an eleventh parabola f₁₁(a) passing through the point corresponding to the target speed and one point positioned in the acceleration section, and a twelfth parabola f₁₂(a) and a thirteenth parabola f₁₃(a) which pass the remaining two points positioned in the acceleration section. Here, the eighth to thirteenth parabolas f₈(a) to f₁₃(a) may be deceleration parabolas. However, one or more embodiments are not limited thereto.

In operation S230, the computing device 100 may set the third boundary line.

In various embodiments, the computing device 100 may set the third boundary line in the form of a straight line combination including a plurality of straight lines in which a jerk value is 0 or is proportional to an acceleration in the domain zone. Here, the third boundary line may include first to third unit boundary lines.

More specifically, first, the computing device 100 may set the first unit boundary line in the form of a constant function which has a jerk value of 0 and in which an acceleration value according to a speed change is a preset positive minimum acceleration value or a preset negative minimum acceleration value. For example, the computing device 100 may set a first unit boundary line (a=g_{p_1}(v)) in the acceleration section in which an acceleration value according to a speed change is a preset positive minimum acceleration value, and a first unit boundary line (a=g_{n_1}(v)) in the deceleration section in which an acceleration value according to a speed change is a preset negative minimum acceleration value.

In addition, the computing device 100 may set two third unit boundary lines which in the form of a constant function which has a jerk value of 0 and in which an acceleration value according to a speed change is a preset positive maximum acceleration value or a preset negative maximum acceleration value. For example, the computing device 100 may set a third unit boundary line (a=g_{p_3}(v)) in the acceleration section in which an acceleration value according to a speed change is a preset positive maximum acceleration value, and a third unit boundary line (a=g_{p_3}(v)) in the deceleration section in which an acceleration value according a speed change is a preset negative maximum acceleration value.

Thereafter, the computing device 100 may connect the first unit boundary line and the third unit boundary line and may set a second unit boundary line in the form of a first-order function having a jerk value with a size proportional to an acceleration value according to a speed change. For example, the computing device 100 may set a second unit boundary line (a=g_{p_2}(v)) in the acceleration section which connects the first unit boundary line (a=g_{p_1}(v)) in the acceleration section and the third unit boundary line (a=g_{p_3}(v)) in the acceleration section, and may set a second unit boundary line (a=g_{n_2}(v)) in the deceleration section which connects the first unit boundary line (a=g_{n_1}(v)) in the deceleration section and the third unit boundary line (a=g_{n_3}(v)) in the deceleration section.

Here, a gradient c of the second unit boundary line may be determined based on the maximum acceleration/deceleration value, the minimum acceleration/deceleration value, a difference value between the target speed and a speed corresponding to the maximum acceleration/deceleration value based on a predefined speed-acceleration relation, and a difference value between the target speed and a speed corresponding to the minimum acceleration/deceleration value based on the predefined speed-acceleration relation among a plurality of parameters.

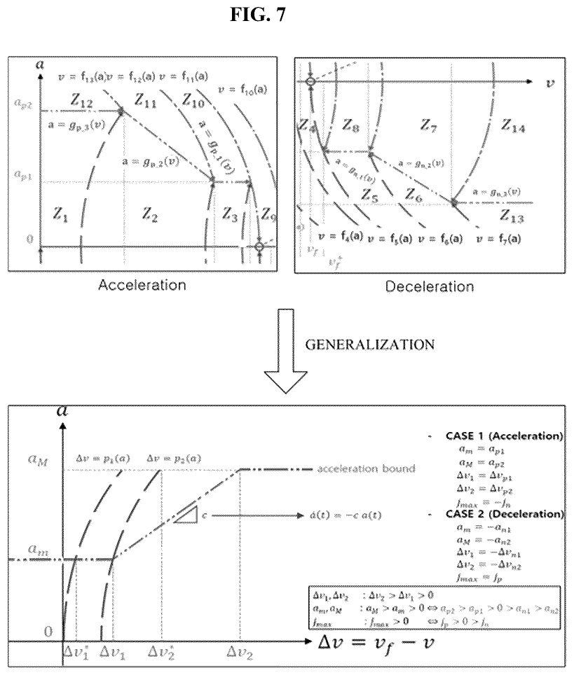

Referring to FIG. 7, in the acceleration section, when the maximum positive acceleration value is aₚ₂, the positive minimum acceleration value is aₚ₁, a difference value Δv₁ between the target speed and the speed corresponding to the positive minimum acceleration value based on the predefined speed-acceleration relation is Δvₚ₁, and a difference value Δvₚ₂ between the target speed and the speed corresponding to the positive maximum acceleration value based on the predefined speed-acceleration relation is Δvₚ₂, the computing device 100 may calculate the gradient c of the second unit boundary line (a=g_{p_2}(v)) in the acceleration section as (aₚ₁−aₚ₂)/(Δvₚ₁−Δvₚ₂). In this case, the gradient of the second unit boundary line (a=g_{p_2}(v)) in the acceleration section may be set not to exceed the maximum jerk value jₘₐₓ.

Similarly, in the deceleration section, when the negative maximum acceleration value is aₐ₂, the negative minimum acceleration value is aₐ₁, a difference value Δv₁ between the target speed and the speed corresponding to the negative minimum acceleration value based on the predefined speed-acceleration relation is Δvₙ₁, and a difference value Δv₂ between the target speed and the speed corresponding to the positive maximum acceleration value based on the predefined speed-acceleration relation is Δvₙ₂, the computing device 100 may calculate the gradient c of the second unit boundary line (a=g_{n_2}(v)) in the deceleration section as (aₐ₂−aₐ₁)/(Δvₙ₂−Δvₙ₁). In this case, the gradient of the second unit boundary line (a=g_{n_2}(v)) in the deceleration section may also be set not to exceed the maximum jerk value jₘₐₓ.

In this case, parameters used in determining the gradient c of the second unit boundary line may be values set such that conditions in Expression 3 below are satisfied, but are not limited thereto.

$$Δ {v}_{1} , Δ {v}_{2} : Δ {v}_{2} > Δ {v}_{1} > 0 \qquad Expression 3$$

$${a}_{m} , {a}_{M} : {a}_{M} > {a}_{m} > 0 ⇔ {a}_{p 2} > {a}_{p 1} > 0 > {a}_{n 1} > {a}_{n 2}$$

$${j}_{max} : {j}_{max} > 0 ⇔ {j}_{p} > 0 > {j}_{n}$$

Meanwhile, since the first boundary line and the second boundary line are set in the form of a parabola with curvature of a predetermined size, and the second unit boundary line included in the third boundary line is formed in the form of a first-order function with a predetermined gradient, in some cases, when the gradient of the second unit boundary line is sufficiently large, the first boundary line and the second unit boundary line and/or the second boundary line and the second unit boundary line may intersect each other at two points, and there is a problem in that, when the boundary lines intersect each other at two points in this way, zones are not properly divided.

In consideration of these points, the computing device 100 may set a plurality of parameters allowing preset constraints to be satisfied.

Here, the preset constraints may be set such that each of a plurality of parabolas, which are included in the first boundary line and generated through a method of setting a plurality of zones using a plurality of parameters (for example, FIG. 5), and the third boundary line have one intersection point, and each of a plurality of parabolas, which are included in the second boundary line and generated through the method of setting a plurality of zones using a plurality of parameters, and the third boundary line have one intersection point.

A an example, the preset constraints may be expressed as in Expressions 4 and 5 below.

$$Δ {v}_{2} - \frac{{a}_{M}^{2}}{2 {j}_{max}} > Δ {v}_{1} - \frac{{a}_{m}^{2}}{2 {j}_{max}} \geq 0 \qquad 〈 Expression 4 〉$$

$$from Δ {v}_{2} > Δ {v}_{2}^{*} > Δ {v}_{1} \geq Δ {v}_{1}^{*} > 0$$

$$with {p}_{1} ( a ) = \frac{1}{2 {j}_{max}} {a}^{2}$$

$${p}_{2} ( a ) = \frac{1}{2 {j}_{max}} {a}^{2} + ( Δ {v}_{1} - \frac{{a}_{m}^{2}}{2 {j}_{max}} )$$

$${j}_{max} ( Δ {v}_{2} - Δ {v}_{1} ) \geq {a}_{M} ( {a}_{M} - {a}_{M} ) \qquad 〈 Expression 5 〉$$

$$from {j}_{n} \leq j = \dot{a} = - ca \leq {j}_{p}$$

As an example, when, in the acceleration section, the maximum positive acceleration value is aₚ₂, he positive minimum acceleration value is aₚ₁, a difference value Δv₁ between a target speed v_{f} and a speed corresponding to the positive minimum acceleration value based on a predefined speed-acceleration relation is Δvₚ₁, the maximum jerk value for the acceleration section is jₙ, and a difference value Δv₂ between the target speed and a speed corresponding to the maximum positive acceleration value based on the predefined speed-acceleration relation is Δvₚ₂, the computing device 100 may verify whether Expressions 6 and 7 below are satisfied.

$$2 {j}_{n} Δ {v}_{p 2} + {a}_{p 2}^{2} < 2 {j}_{n} Δ {v}_{p 1} + {a}_{p 1}^{2} \leq 0 \qquad 〈 Expression 6 〉$$

$${j}_{n} ( Δ {v}_{p 1} - Δ {v}_{p 2} ) \geq {a}_{p 2} ( {a}_{p 2} - {a}_{p 1} ) \qquad 〈 Expression 7 〉$$

In addition, when, in the deceleration section, the maximum negative acceleration value is aₐ₂, the negative minimum acceleration value is aₐ₁, the maximum jerk value is jₚ, the difference value Δv₁ between the target speed v_{f} and the speed corresponding to the negative minimum acceleration value based on the predefined speed-acceleration relation is Δvₙ₁, and the difference value Δv₂ between the target speed v_{f} and the speed corresponding to the maximum positive acceleration value based on the predefined speed-acceleration relation is Δvₙ₂, the computing device 100 may verify whether Expressions 8 and 9 below are satisfied.

$$2 {j}_{p} Δ {v}_{n 2} + {a}_{n 2}^{2} < 2 {j}_{p} Δ {v}_{n 2} + {a}_{n 1}^{2} \leq 0 \qquad 〈 Expression 8 〉$$

$${j}_{p} ( Δ {v}_{n 1} - Δ {v}_{n 2} ) \geq {a}_{n 2} ( {a}_{n 2} - {a}_{n 1} ) \qquad 〈 Expression 9 〉$$

As described above, the computing device 100 basically sets a boundary within a range in which the autonomous driving system does not violate allowed design constraints and sets a boundary to include a current speed of the autonomous vehicle 10 and a used section.

In addition, in consideration of the constraints and response characteristics of the autonomous vehicle 10, the computing device 100 determines acceleration/deceleration boundary values (for example, the maximum acceleration/deceleration value and the minimum acceleration/deceleration value) and thus sets a boundary line.

Here, the consideration of the response characteristics may mean that, in order to prevent a phenomenon in which a target speed is reached after an infinite time (that is, a convergence phenomenon), the first unit boundary line included in the third boundary line is designed in the form of a constant function that outputs a constant acceleration value according to a speed change.

In operation S240, the computing device 100 may set a plurality of zones by dividing a speed-acceleration domain zone using the first boundary line, the second boundary line, and the third boundary line set through operations S210 to S230.

As shown in FIG. 6, the plurality of zones set according to the above-described method may include first to fourteenth zones Z₁ to Z₁₄.

First, based on a plurality of boundary lines set in the domain zone, a zone in which an acceleration is less than 0, and a speed is greater than 0 and less than an output value of the first parabola f₁(a) may be set as a zeroth zone Z₀ or “not a “zone.”

Next, the first zone Z₁ may be the remaining zone in which, in the speed-acceleration domain zone, the zeroth zone Z₀ is subtracted from a zone in which an acceleration is less than or equal to the positive maximum acceleration value, and a speed is greater than or equal to 0 and less than an output value of the second parabola f₂(a).

Next, the second zone Z₂ may be the remaining zone in which, in the speed-acceleration domain zone, the zeroth zone Z₀ is subtracted from a zone in which an acceleration is less than or equal to a larger value of the positive minimum acceleration value and an acceleration value along the second unit boundary line (a=g_{p_2}(v)) in the acceleration section, and a speed is greater than or equal to an output value of the second parabola f₂(a) and less than an output value of the third parabola f₃(a).

Next, the third zone Z₃ may the remaining zone in which, in the speed-acceleration domain zone, the zeroth zone Z₀ is subtracted from a zone in which an acceleration is less than or equal to the positive minimum acceleration value, and a speed is greater than or equal to the output value of the third parabola f₃(a) and less than an output value of the fourth parabola f₄(a).

Next, the fourth zone Z₄ may be a zone including a 4-1 zone and a 4-2 zone in the speed-acceleration domain zone, that is, a union zone of the a 4-1 zone and the 4-2 zone, wherein the 4-1 zone is a zone in which an acceleration is greater than 0, and a speed is greater than or equal to the output value of the fourth parabola f₄(a) and less than or equal to an output value of an eleventh parabola f₁₁(a), and the 4-2 zone is the remaining zone in which the zeroth zone Z₀ is subtracted from a zone in which an acceleration is greater than or equal to 0, and a speed is greater than or equal to the output value of the fourth parabola f₄(a) and less than an output value of the fifth parabola f₅(a).

Next, the fifth zone Z₅ may be a zone in which, in the speed-acceleration domain zone, an acceleration is less than the negative minimum acceleration value, and a speed is greater than or equal to the output value of the fifth parabola f₅(a) and less than or equal to an output value of the sixth parabola f₆(a).

Next, the sixth zone Z₆ may be a zone in which, in the speed-acceleration domain zone, an acceleration is less than a larger value of the negative maximum acceleration value and a deceleration value along the second unit boundary line (a=g_{n_2}(v)) in the deceleration section, and a speed is greater than the output value of the sixth parabola f₆(a) and is less than an output value of the seventh parabola f₇(a).

Next, the seventh zone Z₇ may be a zone in which, in the speed-acceleration domain zone, an acceleration is greater than or equal to a smaller value of the negative minimum acceleration value and the deceleration value along the second unit boundary line (a=g_{n_2}(v)) in the deceleration section, and a speed is greater than an output value of the ninth parabola f₉(a) and is less than or equal to an output value of the eighth parabola f₅(a).

Next, the eighth zone Z₈ may be a zone in which, in the speed-acceleration domain zone, an acceleration is greater than or equal to the negative minimum acceleration value, and a speed is greater than an output value of the tenth parabola f₁₀(a) and is less than or equal to the output value of the ninth parabola f₉(a).

Next, the ninth zone Z₉ may be a zone including a 9-1 zone and a 9-2 zone in the speed-acceleration domain zone, that is, a union zone of the 9-1 zone and the 9-2 zone, wherein the 9-1 zone is a zone in which an acceleration is greater than or equal to 0, and a speed is greater than an output value of the eleventh parabola f₁₁(a) and less than or equal to the output value of the tenth parabola f₁₀(a), and the 9-2 zone is a zone in which an acceleration is less than 0, and a speed is greater than or equal to the output value of the fifth parabola f₅(a) and less than or equal to the output value of the sixth parabola f₆(a).

Next, the tenth zone Z₁₀ may be a zone in which, in the speed-acceleration domain zone, an acceleration is greater than the positive minimum acceleration value, and a speed is greater than or equal to an output value of the twelfth parabola f₁₂(a) and less than or equal to the output value of the eleventh parabola f₁₁(a).

Next, the eleventh zone Z₁₁ may be a zone in which, in the speed-acceleration domain zone, an acceleration is greater than a smaller value of the positive maximum acceleration value and the acceleration value along the second unit boundary line (a=g_{p_2}(v)) in the acceleration section, and a speed is greater than an output value of the thirteenth parabola f₁₃(a) and is less than the output value of the twelfth parabola f₁₂(a).

Next, the twelfth zone Z₁₂ may be a zone in which, in the speed-acceleration domain, an acceleration is greater than the positive maximum acceleration value, and a speed is greater than or equal to 0 and less than or equal to the output value of the thirteenth parabola f₁₃(a).

Next, the thirteenth zone Z₁₃ may be a zone in which, in the speed-acceleration domain zone, an acceleration is less than the negative maximum acceleration value, and a speed is less than or equal to the output value of the seventh parabola f₇(a).

Finally, the fourteenth Z₁₄ may be a zone in which, in the speed-acceleration domain zone, an acceleration is greater than or equal to the negative minimum acceleration value, and a speed is greater than the output value of the eighth parabola f₅(a).

That is, the computing device 100 may set the plurality of zones by dividing the speed-acceleration domain zone as in Expression 10 below.

$${Z}_{target} = \{ ( {v}_{f} , 0 ) \} \qquad 〈 Expression 10 〉$$

$${Z}_{0} = \{ ( v , a ) ∈ 𝔻 \vert a < 0 , 0 < v < {f}_{1} ( a ) \}$$

$${Z}_{1} = \{ ( v , a ) ∈ 𝔻 \vert a \leq {a}_{p 2} , 0 \leq v < {f}_{2} ( a ) \} \backslash {Z}_{0}$$

$${Z}_{2} = \{ ( v , a ) ∈ 𝔻 \vert a \leq max ( \text{?} ( v ) , {a}_{p 1} ) , {f}_{2} ( a ) \leq v < \text{?} ( a ) ] \backslash {Z}_{0}$$

$${Z}_{3} = \{ ( v , a ) ∈ 𝔻 \vert a \leq {a}_{p 1} , {f}_{3} ( a ) \leq v < {f}_{4} ( a ) ] \backslash {Z}_{0}$$

$${Z}_{4} = \{ ( v , a ) ∈ 𝔻 \vert a > 0 , {f}_{4} ( a ) \leq v \leq \text{?} ( a ) \} ⋃ [ \{ ( v , a ) ∈ 𝔻 \vert a \leq 0 , {f}_{4} ( a ) \leq v < \text{?} ( a ) \} \backslash {Z}_{0} ]$$

$$\text{?} = \{ ( v , a ) ∈ 𝔻 \vert a < {a}_{n 1} , {f}_{5} ( a ) \leq v \leq {f}_{6} ( a ) \}$$

$${Z}_{6} = \{ ( v , a ) ∈ 𝔻 \vert \{ ( v , a ) ∈ 𝔻 \vert a < max ( {g}_{n \_ 2} ( v ) , {a}_{n 2} ) , \text{?} ( a ) < v < {f}_{7} ( a ) \}$$

$${Z}_{7} = \{ ( v , a ) ∈ 𝔻 \vert a \geq min ( {g}_{n \_ 2} ( v ) , {a}_{n 1} ) , {f}_{9} ( a ) < v \leq {f}_{8} ( a ) \}$$

$${Z}_{8} = \{ ( v , a ) ∈ 𝔻 \vert a \geq \text{?} {f}_{10} ( a ) < v \leq \text{?} ( a ) \}$$

$${Z}_{9} = \{ ( v , a ) ∈ 𝔻 \vert a \geq 0 , {f}_{11} ( a ) \leq v \leq {f}_{10} ( a ) \} ⋃ \{ ( v , a ) ∈ 𝔻 \vert a \leq 0 , {f}_{5} ( a ) \leq v < {f}_{6} ( a ) \}$$

$${Z}_{10} = \{ ( v , a ) ∈ 𝔻 \vert a > \text{?} {f}_{12} ( a ) \leq v \leq {f}_{11} ( a ) \}$$

$${Z}_{11} = \{ ( v , a ) ∈ 𝔻 \vert a \geq min ( {g}_{p \_ 2} ( v ) , {a}_{p 2} ) , {f}_{13} ( a ) < v \leq {f}_{12} ( a ) \}$$

$${Z}_{12} = \{ ( v , a ) ∈ 𝔻 \vert a > {a}_{p 2} , 0 \leq v \leq \text{?} ( a ) \}$$

$${Z}_{13} = \{ ( v , a ) ∈ 𝔻 \vert a < {a}_{n 2} , v \geq {f}_{7} ( a ) \}$$

$${Z}_{14} = \{ ( v , a ) ∈ 𝔻 \vert a \geq {a}_{n 2} , v > \text{?} ( a ) \}$$

$$\text{?} \text{indicates text missing or illegible when filed}$$

Referring again to FIG. 3, in operation S120, the computing device 100 may select a zone corresponding to a current speed and acceleration of the autonomous vehicle 10 among the plurality of zones set through operation S110 (for example, zone determination of FIG. 4).

In various embodiments, the computing device 100 may select a zone in which a point (v₀, a₀) corresponding to a current speed and acceleration of the autonomous vehicle 10 is positioned among the plurality of zones set in the domain zone.

In operation S130, the computing device 100 may generate a speed profile for controlling a speed such that a speed of the autonomous vehicle 10 reaches a target speed based on the zone selected through operation S120 (for example, speed profile generation of FIG. 4).

In various embodiments, when a specific zone among the plurality of zones corresponds to the point corresponding to the current speed and acceleration of the autonomous vehicle 10, the computing device 100 may generate a speed profile for controlling a speed and acceleration of the autonomous vehicle 10 such that the point corresponding to the current speed and acceleration of the autonomous vehicle 10 moves along a speed-acceleration relation corresponding to the specific zone.

In this case, the computing device 100 may control a speed and acceleration of the autonomous vehicle 10 such that a point corresponding to the speed and acceleration of the autonomous vehicle 10 moves along a speed-acceleration relation corresponding to a specific zone, and when the point corresponding to the speed and acceleration of the autonomous vehicle 10 is positioned on a specific boundary line in the domain zone, the computing device 100 may generate a speed profile for controlling the speed and acceleration of the autonomous vehicle 10 such that the point corresponding to the speed and acceleration of the autonomous vehicle 10 moves along the specific boundary line.

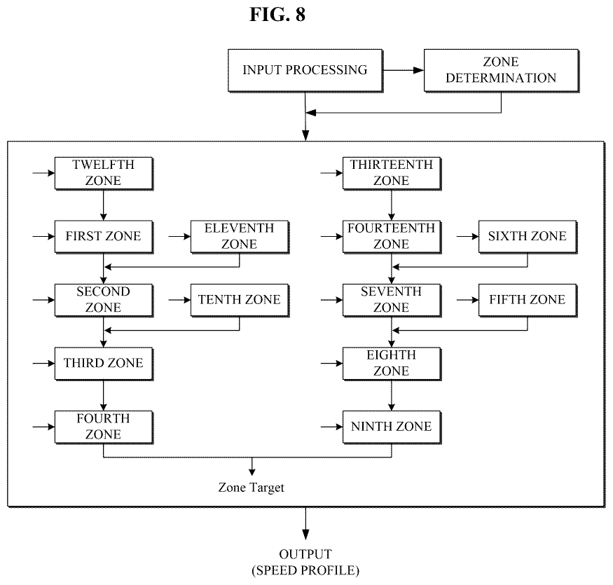

As an example, referring to FIGS. 6 and 8, when a point corresponding to a speed and acceleration of the autonomous vehicle 10 is positioned in the first zone Z₁, the computing device 100 may generate a speed profile for controlling a speed and acceleration of the autonomous vehicle 10 according to the following order.
(1) A speed and acceleration of the autonomous vehicle 10 are controlled such that a point corresponding to an initial state (for example, an initial speed and initial acceleration) of the autonomous vehicle 10 follows a parabola (not shown), which is parallel to f₁(a) and f₂(a) which are speed-acceleration relations corresponding to the first zone Z₁, in the first zone Z₁.
(2) When, as an acceleration of the autonomous vehicle 10 reaches aₚ₂, and a point corresponding to a speed and acceleration of the autonomous vehicle 10 is positioned on the third unit boundary line (a=g_{p_3}(v)) set in the acceleration section, the speed and acceleration of the autonomous vehicle 10 are controlled such that a point corresponding to the speed and acceleration of the autonomous vehicle 10 follows the third unit boundary line (a=g_{p_3}(v)) set in the acceleration section.
(3) When, as a speed of the autonomous vehicle 10 reaches vₚ₂, and a point corresponding to the speed and acceleration of the autonomous vehicle 10 is positioned on the second unit boundary line (a=g_{p_2}(v)) set in the second zone Z₂, the speed and acceleration of the autonomous vehicle 10 are controlled such that the point corresponding to the speed and acceleration of the autonomous vehicle 10 follows the second unit boundary line (a=g_{p_2}(v)) set in the second zone Z₂.
(4) When, an acceleration of the autonomous vehicle 10 reaches aₚ₁, and a point corresponding to the speed and acceleration of the autonomous vehicle 10 is positioned on the first unit boundary line (a=g_{p_1}(v)) set in the third zone Z₃, the speed and acceleration of the autonomous vehicle 10 are controlled such that the point corresponding to the speed and acceleration of the autonomous vehicle 10 follows the first unit boundary line (a=g_{p_1}(v)) set in the third zone Z₃.
(5) When a difference between a speed of the autonomous vehicle 10 and the target speed v_{f} is less than a threshold value and is positioned on f₁₁(a) set in the fourth zone Z₄, control is performed such that a point corresponding to the speed and acceleration of the autonomous vehicle 10 follows f₁₁(a) set in the fourth zone Z₄.

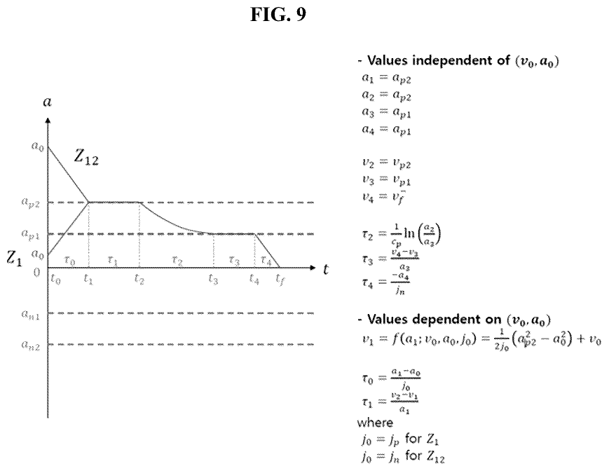

As described above, the computing device 100 generates a speed profile such that, based on an initial zone corresponding to initial parameters (for example, a current speed, current acceleration, and target speed) of the autonomous vehicle 10, a point corresponding to a speed and acceleration of the autonomous vehicle 10 follows a parabola according to a speed-acceleration relation corresponding to the initial zone, and when the point corresponding to the speed and acceleration of the autonomous vehicle 10 is positioned on a specific boundary line, the point follows the specific boundary line. The speed profiles generated through such a method are as shown in FIGS. 9 to 15.

In various embodiments, the computing device 100 may perform exception processing (for example, input processing of FIG. 4) on input data (current speed, acceleration, and target speed of the autonomous vehicle 10) based on a current speed of the autonomous vehicle 10 and a target speed.

As an example, when a difference between the current speed of the autonomous vehicle 10 and the target speed is less than a threshold value, the computing device 100 may generate a speed profile for controlling the autonomous vehicle 10 to maintain the current speed.

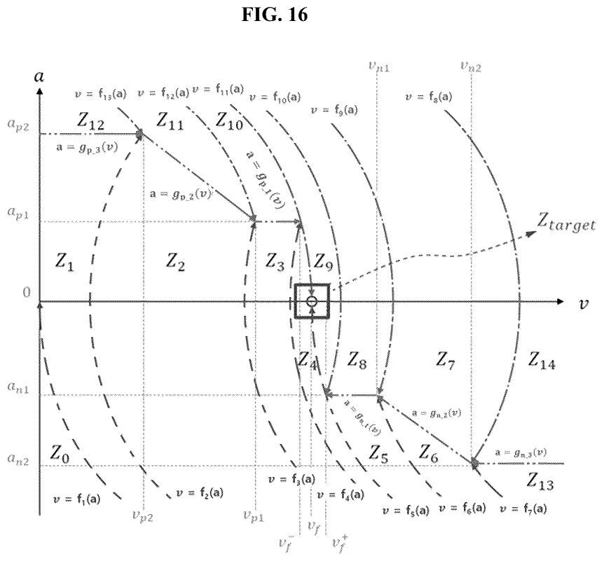

When the current speed of the autonomous vehicle 10 is already sufficiently close to the target speed, a process itself of generating a speed profile that causes the current speed to reach the target speed may be inefficient. In consideration of these points, as shown in FIG. 16, the computing device 100 may set a target speed zone Z_{target} in a predetermined range centered on a point (v_{f}, 0) corresponding to the target speed, and when a point corresponding to a current speed and acceleration of the autonomous vehicle 10 is positioned in the target speed zone Z_{target}, without generating a separate speed profile, the computing device 100 may allow a speed of the autonomous vehicle 10 to be controlled using a previously generated speed profile to control the autonomous vehicle 10 to maintain a current speed.

Here, the target speed zone Z_{target} is a zone that serves as a criterion for determining whether a current speed of the autonomous vehicle 10 is sufficiently close to a target speed and is a zone that is set in advance. As in Expression 11, the target speed zone Z_{target} may be a zone in which a size of a difference between the current speed of the autonomous vehicle 10 and the target speed is equal to or less than a threshold speed v_{threshold}, and a magnitude of a current acceleration of the autonomous vehicle 10 is equal to or less than a threshold acceleration a_{threshold}.

$${Z}_{target} = \{ ( v , a ) ∈ 𝔻 \vert \vert v - {v}_{f} \vert \leq {v}_{threshold} , \vert a \vert \leq {a}_{threshold} \qquad 〈 Expression 11 〉$$

As another example, when there is no zone corresponding to a current speed and acceleration of the autonomous vehicle 10 among the plurality of zones, or when the zone corresponding to the current speed and acceleration of the autonomous vehicle 10 is the zeroth zone Z₀, the computing device 100 may first generate a first speed profile for performing control such that a speed and acceleration of the autonomous vehicle 10 are 0, and when the current speed and acceleration of the autonomous vehicle 10 become 0 according to the first speed profile, the computing device 100 may generate a second speed profile using a zone corresponding to the current speed and acceleration of the autonomous vehicle 10 of 0 among the plurality of zones.

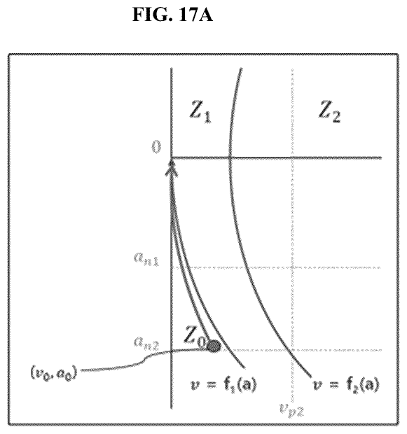

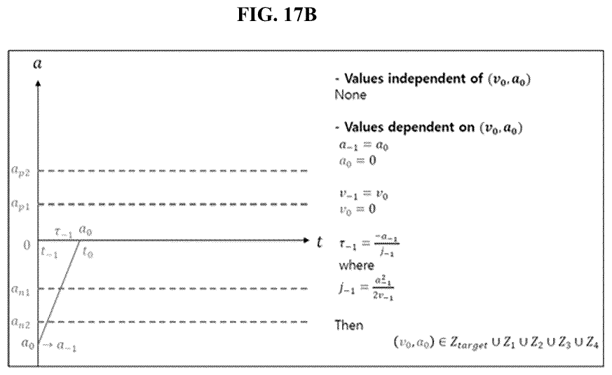

For example, first, as shown in FIG. 17A, when a point (v₀, a₀) corresponding to a speed and acceleration of the autonomous vehicle 10 is positioned in the zeroth zone Z₀ as a point (v_{-1, a-1}), the computing device 100 may generate the first speed profile for performing control such that an initial speed v₋₁, and an initial acceleration a₋₁ of the autonomous vehicle 10 are 0.

In this case, the first speed profile may be designed in the form of a linear function as shown in FIG. 17B and may be designed to perform control such that an acceleration of the autonomous vehicle 10 is changed from a₋₁ to 0 within a predetermined time τ₋₁. Here, the predetermined time τ₋₁ may be a time constant representing a time interval between a time point t₋₁ when an acceleration of the autonomous vehicle 10 is a₋₁ and a time point t₀ when an acceleration of the autonomous vehicle 10 is 0 and may be defined as in Expression 12 below.

$${τ}_{- 1} = \frac{- {a}_{- 1}}{{j}_{- 1}} \qquad 〈 Expression 12 〉$$

$$where$$

$${j}_{- 1} = \frac{{a}_{- 1}^{2}}{2 {v}_{- 1}}$$

Thereafter, as shown in FIG. 17A, when the point (v₀, a₀) corresponding to the speed and acceleration of the autonomous vehicle 10 according to the first speed profile becomes a point (0, 0) and thus is positioned in the first zone Z₁, the computing device 100 may generate the second speed profile (for example, FIG. 9) for the autonomous vehicle 10 based on the first zone Z₁.

As another example, when it is determined that a current speed is less than a target speed in a state in which an acceleration is a negative value, or a current speed is greater than the target speed in a state in which the acceleration is a positive value, the computing device 100 may generate a speed profile for reversing an acceleration direction of the autonomous vehicle 10 based on a preset jerk value.

For example, the computing device 100 may set a jerk jump zone Zⱼᵤₘₚ by applying a preset jerk value to a zone in which a current speed is less than a target speed in a state in which an acceleration is a negative value and a zone in which a current speed is greater than the target speed in a state in which an acceleration is a positive value. When a point corresponding to a current speed and acceleration is positioned in the zone in which the current speed is less than the target speed in a state in which the acceleration is a negative value or the zone in which the current speed is greater than the target speed in a state in which the acceleration is a positive value, the computing device 100 may generate a speed profile for performing control such that the point corresponding to the current speed and acceleration of the autonomous vehicle 10 moves to the jerk jump zone Zⱼᵤₘₚ set to correspond to a corresponding zone.

Here, the jerk jump zone Zⱼᵤₘₚ may be defined as in Expression 13 below.

$${Z}_{jump} = \{ ( v , a ) ∈ 𝔻 \vert a ( {v}_{f} - v ) < 0 , ( v , a ) ∉ {Z}_{target} \} \qquad 〈 Expression 13 〉$$

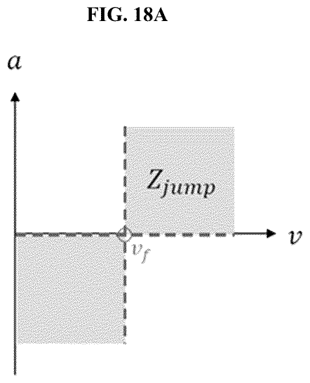

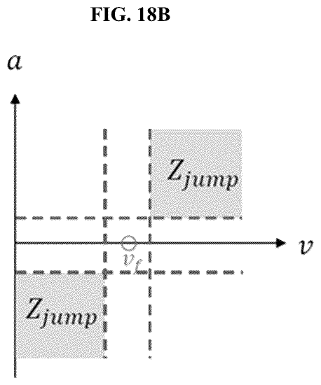

In this case, as shown in FIG. 18A, when the jerk jump zone Zⱼᵤₘₚ is set very close to a point corresponding to the target speed, there is a problem in that, due to frequent jerk jumps at the point corresponding to the target speed, ride comfort is excessively lowered.

In consideration of these points, the computing device 100 sets the jerk jump zone Zⱼᵤₘₚ, and as shown in FIG. 18B, sets the jerk jump zone Zⱼᵤₘₚ by leaving a margin with a predetermined size centered on the point corresponding to the target speed, thereby preventing frequent jerk jumps and securing excellent deceleration or acceleration responsiveness.

The jerk jump zone Zⱼᵤₘₚ set as above may be defined as in Expression 14 below.

$$〈 Expression 14 〉$$

$${Z}_{jump} = \{ ( v , a ) ∈ 𝔻 \backslash {Z}_{target} \vert a > {a}_{thr}^{+} , v > {v}_{f} - {v}_{thr}^{-} \} ⋃ \{ ( v , a ) ∈ 𝔻 \backslash {Z}_{target} \vert a < {a}_{thr}^{-} , v < {v}_{f} - {v}_{thr}^{+} \}$$

According to various embodiments of the present invention, a plurality of zones are set by dividing a two-dimensional domain zone defined by a speed and acceleration according to a predefined speed-acceleration relation, and a speed profile for an autonomous vehicle is generated based on a zone corresponding to a current speed and acceleration of the autonomous vehicle, thereby generating a speed profiles that allows excellent ride comfort to be maintained even in a wide speed range when a current speed is increased or decreased to reach a target speed.

In particular, by quickly accelerating/decelerating using high acceleration/deceleration when a difference between a current speed and a target speed is large, and relatively slowly accelerating/decelerating when the difference between the current speed and the target speed is small, a speed profile that enables a response to various driving situations and speed ranges is generated, thereby smoothly controlling a speed while maintaining ride comfort and improving responsiveness according to situations.

In addition, by generating a speed profile in which an acceleration is implemented in the form of a piecewise linear function, which is easy to follow, rather than a step function, the control performance of an autonomous vehicle can be improved, and thus speed control in which ride comfort is improved can be performed.

The effects of the present invention are not limited to the effects described above, and other effects not described will be clearly understood from the following description by those skilled in the art.

The above-described method of generating a speed profile for speed control of the autonomous vehicle has been described with reference to the flowchart shown in the drawing. While, for purposes of simplicity of description, the method of generating a speed profile for speed control of an autonomous vehicle has been illustrated and described as a series of blocks, it is to be appreciated that the present invention is not limited by the order of blocks, as some blocks may occur in different orders and/or concurrently with other blocks from what shown and described herein. In addition, new blocks that are not described in this specification and drawings may be added, or some blocks may be omitted or changed.

In the above, although embodiments of the present invention have been described with reference to the accompanying drawings, those skilled in the art may understand that the present invention may be embodied in other specific forms without changing the technical spirit or essential features thereof. Accordingly, it should be understood that the above-described embodiments are exemplary in all respects and not restrictive.

What is claimed is:

1. A method of generating a speed profile for speed control of an autonomous vehicle, which is performed by a computing device, the method comprising:
setting a plurality of zones by dividing a two-dimensional domain zone defined by a speed and an acceleration;
selecting a zone corresponding to a current speed and acceleration of an autonomous vehicle among the plurality of zones; and
generating a speed profile for controlling a speed such that a speed of the autonomous vehicle reaches a target speed based on the selected zone.

2. The method of claim 1, wherein the setting of the plurality of zones includes:
setting a plurality of parameters related to a speed, an acceleration, and a jerk;
setting a plurality of boundary lines in the domain zone using the plurality of set parameters; and
setting the plurality of zones by dividing the domain zone using the plurality of set boundary lines.

3. The method of claim 2, wherein the setting of the plurality of boundary lines includes:
setting a first boundary line in a form of an acceleration parabola in the domain zone;
setting a second boundary line in a form of a deceleration parabola in the domain zone; and
setting a third boundary line in a form of a straight line combination including a plurality of different straight lines in the domain zone.

4. The method of claim 3, wherein the setting of the first boundary line includes setting a plurality of parabolas, which have a first jerk value and individually pass a zero point in the domain zone, points corresponding to boundaries of sections of the plurality of straight line, and a point corresponding to the target speed, based on a predefined speed-acceleration relation.

5. The method of claim 3, wherein the setting of the second boundary line includes setting a plurality of parabolas, which have a second jerk value and individually pass points corresponding to boundaries of sections of the plurality of straight line in the domain zone and a point corresponding to the target speed, based on a predefined speed-acceleration relation.

6. The method of claim 3, wherein the setting of the third boundary line includes:
setting a first unit boundary line in a form of a constant function which has a jerk value of 0 and in which an acceleration value according to a speed change is a preset positive minimum acceleration value or a preset negative maximum acceleration value;
setting a second unit boundary line in a form of a constant function which has a jerk value of 0 and in which an acceleration value according to a speed change is a preset positive maximum acceleration value or a preset negative minimum acceleration value; and
setting a third unit boundary line in a form of a first-order function which connects the set first unit boundary line and the set second unit boundary line and has a jerk value proportional to an acceleration value according to a speed change.

7. The method of claim 2, wherein the setting of the plurality of parameters includes setting the plurality of parameters such that preset constraints are satisfied,
wherein the preset constraints are set such that each of a plurality of parabolas included in a first boundary line generated using the plurality of set parameters and a third boundary line generated using the plurality of set parameters have one intersection point, and each of a plurality of parabolas included in a second boundary line generated using the plurality of set parameters and the third boundary line have one intersection point.

8. The method of claim 2, wherein the plurality of set parameters include at least one of a positive maximum acceleration value, a positive minimum acceleration value, a negative maximum acceleration value, a negative minimum acceleration value, a jerk value, a difference value between the target speed and a speed corresponding to the positive maximum acceleration value based on a predefined speed-acceleration relation, a difference value between the target speed and a speed corresponding to the positive minimum acceleration value based on the predefined speed-acceleration relation, a difference value between the target speed and a speed corresponding to the negative maximum acceleration value based on the predefined speed-acceleration relation, and a difference value between the target speed and a speed corresponding to the negative minimum acceleration value based on the predefined speed-acceleration relation.

9. The method of claim 1, wherein the selecting of the zone includes selecting a zone, in which a point corresponding to the current speed and acceleration of the autonomous vehicle is positioned, among the plurality of zones set in the domain zone.

10. The method of claim 9, wherein the generating of the speed profile includes:
generating a speed profile for controlling the speed and acceleration of the autonomous vehicle such that a point corresponding to the speed and acceleration of the autonomous vehicle follows a parabola parallel to a speed-acceleration relation corresponding to the selected zone and, the point corresponding to the speed and acceleration of the autonomous vehicle follows a specific boundary line when the point corresponding to the speed and acceleration of the autonomous vehicle is positioned on the specific boundary line in the domain zone.

11. The method of claim 1, further comprising, when a difference between the current speed and the target speed is less than a threshold value, generating a speed profile for controlling the autonomous vehicle to maintain the current speed.

12. The method of claim 1, further comprising:
when there is no zone corresponding to the current speed and acceleration of the autonomous vehicle among the plurality of set zones, generating a first speed profile for performing control such that a speed and acceleration of the autonomous vehicle are 0; and
when the current speed and acceleration of the autonomous vehicle becomes 0 according to the generated first speed profile, generating a second speed profile using a zone corresponding to the current speed and acceleration of the autonomous vehicle being 0 among the plurality of set zones.

13. The method of claim 1, further comprising, when it is determined that the current speed is less than the target speed in a state in which the acceleration is a negative value, or the current speed is greater than the target speed in a state in which the acceleration is a positive value, generating a speed profile for reversing an acceleration direction of the autonomous vehicle based on a preset jerk value.

14. The method of claim 13, wherein the generating of the speed profile for reversing the acceleration direction of the autonomous vehicle includes generating the speed profile for reversing the acceleration direction of the autonomous vehicle only when a difference between the current speed and the target speed is greater than or equal to a threshold value.

15. The method of claim 1, wherein the setting of the plurality of zones includes dividing the two-dimensional domain zone to include a section using an acceleration having a magnitude proportional to a difference between the speed of the autonomous vehicle and the target speed.

16. A computing device for performing a method of generating a speed profile for speed control of an autonomous vehicle, the computing device comprising:
a processor;
a network interface;
a memory; and
a computer program loaded to the memory and executed by the processor,
wherein the computer program includes:
an instruction for setting a plurality of zones by dividing a two-dimensional domain zone defined by a speed and an acceleration;
an instruction for selecting a zone corresponding to a current speed and an acceleration of an autonomous vehicle among the plurality of zones; and
an instruction for generating a speed profile for controlling a speed such that a speed of the autonomous vehicle reaches a target speed based on the selected zone.

17. A computing device-readable recording medium, on which a computer program coupled to a computing device to execute a method of generating a speed profile for speed control of an autonomous vehicle is recorded, wherein the method includes:
setting a plurality of zones by dividing a two-dimensional domain zone defined by a speed and an acceleration;
selecting a zone corresponding to a current speed and an acceleration of an autonomous vehicle among the plurality of zones; and
generating a speed profile for controlling a speed such that a speed of the autonomous vehicle reaches a target speed based on the selected zone.
